(19) United States
(12) Patent Application Publication
(10) Pub. No.: US 2026/0141557 A1
(43) Pub. Date: May 21, 2026

(54) Dashcam Network with Route Logging and Computer Vision for Targeted Video Search Capabilities

(71) Applicant: Nicholas Demes Owens, Sarasota, FL (US)

(72) Inventor: Nicholas Demes Owens, Sarasota, FL (US)

(21) Appl. No.: 18/954,625

(22) Filed: Nov. 21, 2024

(51) Int. Cl. G06T 7/73

(52) U.S. Cl. CPC G06T 7/74; G06T 2207/10016; G06T 2207/30241; G06T 2207/30252

(57) ABSTRACT

The present invention discloses a system to assist investigations for storage and targeted search of metadata and video collected by dashcams. The invention efficiently guides video evidence search using stored route metadata versus complete footage, tackling the challenges of distributed footage across vehicles. The system enhances investigations by unlocking previously inaccessible visual evidence in a targeted manner while optimizing storage and bandwidth. Vehicles equipped with cameras send real-time route metadata and/or video to the system. This data may include coordinates, timestamps, license plates detected, facial features, street names, addresses, suspicious behavior data, and other details related to the route. Investigators may input search parameters related to location, timing, vehicles, objects, persons, etc. Computer vision algorithms analyze stored metadata to identify matching routes and footage. Investigators may access the video from central storage or, if only metadata about the route was submitted, request relevant footage from the respective driver.

### FIELD OF INVENTION

The present invention relates to the field of video search systems. More specifically, this invention relates to a centralized storage and search platform that collects real-time route data from networked dashcams. It enables targeted searching of the stored video footage using computer vision techniques to assist investigators in locating visual evidence relevant to cases. The system bridges the gap between fragmented, inaccessible dashcam footage and the investigative need for accessing such video evidence in a timely and targeted manner.

### BACKGROUND OF THE INVENTION

Dashcams have become a popular accessory for vehicles, with adoption growing rapidly in recent years. These cameras provide continuous video recording of a vehicle's surroundings and travels. However, dashcam systems today work in isolation, with the footage being stored locally on SD cards with limited capacity. Video gets overwritten within days or weeks, after which the potential evidence is lost forever.

At the same time, investigators often struggle to obtain useful visual evidence for solving crimes and finding leads. Fixed security cameras have limited coverage, leaving huge blindspots in the path of a suspect vehicle. Canvassing businesses for footage is time-consuming and rarely fruitful. Yet, unbeknownst to drivers, dashcams capture and erase vital clues everyday that could prove invaluable in closing cases.

The need for accessing such footage is more dire than ever. As per FBI statistics, over 1.2 million violent crimes occurred nationwide in 2020, with only 45% being cleared. Investigators need every tool at their disposal to improve closure rates and justice. However, the distributed and temporary nature of dashcam systems today makes obtaining relevant footage prohibitively difficult.

This invention bridges this gap by proposing a centralized, searchable network of dashcam footage. By collecting real-time route data and enabling targeted searching, the system makes previously inaccessible footage discoverable for investigators. The core innovation is around efficient storage as well as quick retrieval of relevant evidence.

In this system, vehicles send details of routes driven to a central database. Data like coordinates, timestamps, speed, etc. builds a comprehensive log of footage captured. Using computer vision techniques like scene analysis, object recognition, and facial recognition, the platform can index visual contents for searchability.

Investigators can then input customized search parameters related to location, timing, vehicles, objects, and persons. Advanced algorithms efficiently match this criteria against indexed footage to find relevant video evidence. Agents can view and request access to promising candidate clips.

The object of this invention is therefore a video evidence search platform for accelerating and enhancing investigative work. By unlocking the treasure trove of insights captured in dashcams, it aims to aid law enforcement with a powerful new tool for greater efficiency, coverage, and closure rates. The central storage addresses current limitations while search capabilities open up new possibilities.

### SUMMARY OF THE INVENTION

The following summary outlines the key innovations embodied in the system, method, devices, and apparatus described herein. It is important to note that this summary provides a concise overview of the invention's core features without intending to impose limitations beyond the scope defined by the detailed description and claims.

In some embodiments thereof, the present invention discloses a system and method for tracking objects of interest, such as suspects, vehicles, or other physical items, across multiple cameras distributed across different locations.

According to one aspect, the invention teaches an implementation to detect and identify a target object in footage from one camera and then intelligently search stored or live feeds from other geographically and chronologically proximate cameras to trace the object. This is enabled by using advanced computer vision techniques to match the distinguishing features of the object, such as physical attributes, license plate details, facial features, etc.

In another aspect, when the object of interest is detected in the first camera feed, descriptive features are extracted using image analysis. These object descriptors become the unique signature used to efficiently scan other camera feeds for likely matches, while ignoring unlikely candidates. The invention iteratively continues this matching process to follow the object across multiple locations over time.

Optional embodiments may allow incorporating real-time footage from networked cameras to enable live tracking. The system can be implemented in a remote server accessing distributed camera data. Object path reconstruction features can estimate the likely route and timing between matched appearances across non-overlapping camera views.

The invention provides significant investigative utility by unlocking the ability to track key entities seamlessly across fragmented and disconnected camera systems. Some non-limiting use cases include: Tracing the path of suspects or vehicles involved in criminal investigations; Tracking witnesses or persons of interest across locations; Monitoring the movements of known offenders or suspicious entities; and Logistics tracking of vehicles or inventory.

In another aspect, by leveraging computer vision to stitch together insights from distributed cameras, the invention overcomes limitations of isolated surveillance systems. All matching and tracking is done efficiently by analyzing metadata and selected keyframes versus needing entire footage. The disclosed system yields unprecedented visibility into movements across premises and areas for security applications without requiring prohibitively expensive, blanket camera coverage. Object tracking chronicles and potential suspects are transformed from fragments into a cohesive story, accessible from a simple user interface.

### BRIEF DESCRIPTION OF THE DRAWINGS

The novel features believed to be characteristic of the illustrative embodiments are set forth in the appended claims. The illustrative embodiments, as well as a preferred mode of use, will best be understood by reference to the following detailed description when read in conjunction with the accompanying drawings, wherein:

FIG. 1 of the drawings illustrates a vehicle equipped with a dashcam having a field of view, and communicatively coupled to a remote server according to one embodiment.

FIG. 2 of the drawings illustrates a vehicle equipped with a dashcam having a field of view over an accident scene according to one embodiment.

FIG. 3 illustrates a first vehicle equipped with a dashcam having a field of view of an ongoing robbery scene according to one embodiment.

FIG. 4 of the drawings demonstrates a second car dashcam view of the same robbery scene with suspects getting away according to one aspect.

FIG. 5 shows a third car dashcam view of the same robbery scene with suspects in a vehicle driving away according to one embodiment.

FIG. 6 illustrates a fifth car dashcam view of a getaway car at a different location parked at an estate according to one aspect.

FIG. 7 demonstrates a sixth car dashcam view of suspects at a mall parking location seated at a cafe according to one aspect.

FIG. 8 of the drawings shows an operator using an interface with several screens seeing all the various scenes from the six vehicles according to one embodiment.

FIG. 9 of the drawings shows two police officers at the scene of the mall from the sixth car arresting the suspects from FIG. 3.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

Also in this disclosure, a dashcam may be construed to cover any video and/or audio recording devices installed in a vehicle, which may or may not be located on a dashboard.

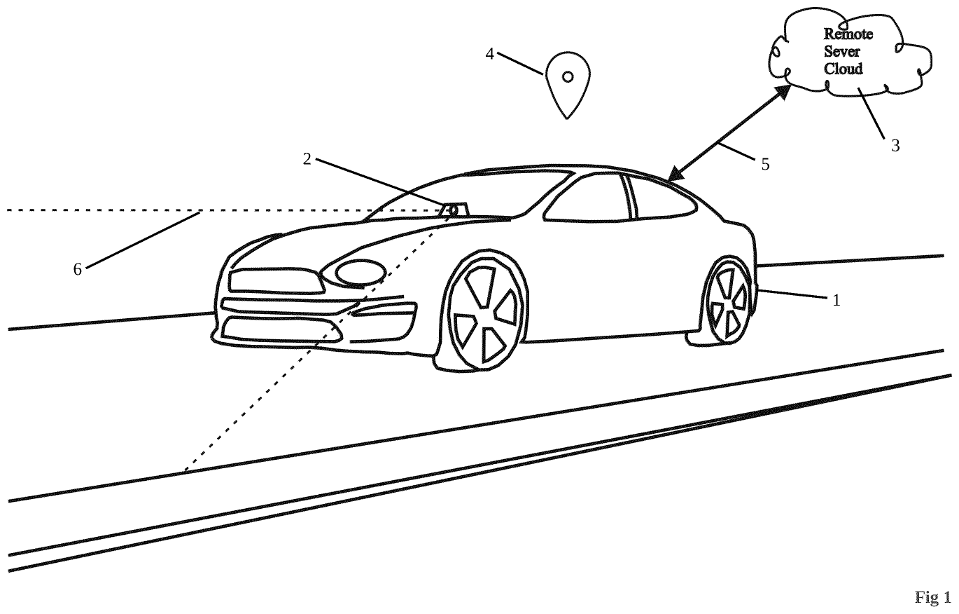

The embodiment according to FIG. 1 of the drawings illustrates a system where a vehicle 1 is shown equipped with a dashcam 2, and being communicatively coupled to a remote server 3. The vehicle 1 is representative of the many client vehicles that may be outfitted with dashcams and connected to the central server.

The dashcam 2 has a field of view that covers the area in front of the moving vehicle 1. It continuously captures video footage of the vehicle's surroundings and travels. This footage may contain critical evidence related to accidents, criminal activity, or other events along the drive. For example, the footage may unintentionally capture a suspect vehicle, person of interest, street signs, building names, or other clues valuable to ongoing investigations. However, this potentially useful evidence remains largely inaccessible today.

The dashcam 2 may have internal storage to save footage locally. But this storage is limited, resulting in footage being overwritten in days or weeks. To address this, the dashcam additionally saves a copy of the footage to the remote server 3 over the network.

A GPS module 4 determines the current location of the vehicle. This location data, along with time stamps, can provide the geographic context for sections of footage. The GPS coordinates at different times can be used to reconstruct the full route that was driven.

According to one aspect, both the video footage as well as route metadata is transmitted real-time to the remote server 3. The server 3 aggregates and stores this data from many connected vehicles. Authorized personnel can then search this expansive footage database to find evidence related to location, time, vehicles, objects etc.

In some aspects, by providing a centralized repository of consolidated footage and an efficient search mechanism, the system makes dashcam videos accessible for investigations in a targeted manner. It may also help uncover insights that may have otherwise been lost due to the distributed and temporary storage limitations of individual dashcams.

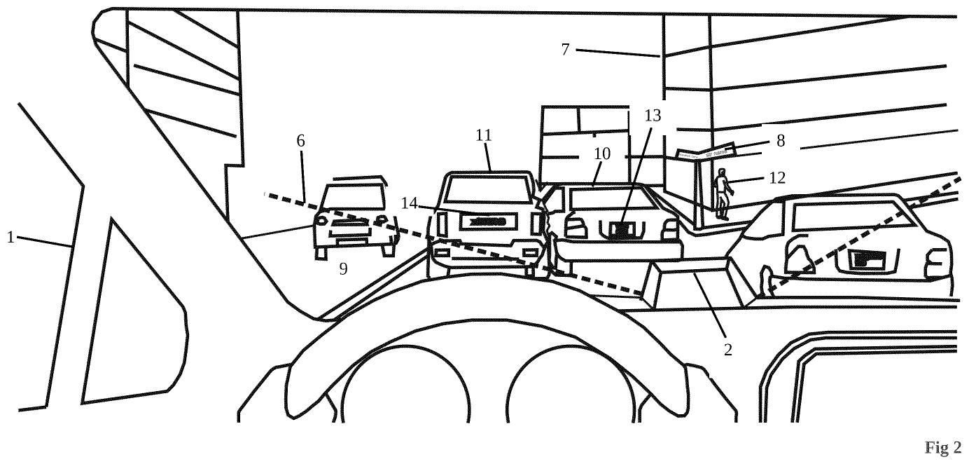

Now making reference to FIG. 2 of the drawings, it illustrates an accident scene 15 captured by the dashcam 2 of a passing vehicle 1. This footage could provide critical evidence for investigating the incident, but would typically not be accessible to authorities.

The dashcam's wide field of view 6 covers the entire accident area. Visible in the scene are two collided vehicles—car 10 with license plate 13 and car 11 with plate 14. An injured person 12 is also present, presumably a victim of the crash. Additionally, a building 7 is visible behind the accident, with the street name 8 also captured indicating the exact location.

All this footage would be invaluable to reconstructing what transpired. However, typically it would simply be overwritten in the dashcam's storage after a few days.

An important capability of the system is the use of computer vision algorithms to automatically analyze and index the video contents. Image recognition techniques can identify that an accident is present based on detected objects. In this aspect, the make and model of the cars, license plate numbers, street signs, building names, and even physical features of individuals can be extracted using object, facial, and optical character recognition techniques.

The metadata extracted using computer vision techniques can then be used to efficiently search the footage database for accidents involving specific vehicles, locations, or people's appearances. Instead of manual review, the footage can be automatically surfaced based on visual searching.

As an example, the system may receive a search request related to a hit and run accident with a suspected fleeing vehicle number. The time and location of the accident is also input to the search. The computer vision module analyzes the indexed visual metadata from dashcam videos around that time and geofence. It may detect matching license plates, car models, and accident imagery. The relevant footage may be automatically identified without human review of hours of video.

An embodiment as illustrated by FIG. 2 improves the efficiency in surfacing valuable evidence from the sea of fragmented dashcam data. As such, investigators get access to photographic evidence from the actual accident scene, which can be crucial in hit and runs. The computer vision capabilities enhance response and closure rates by augmenting investigators with smart search.

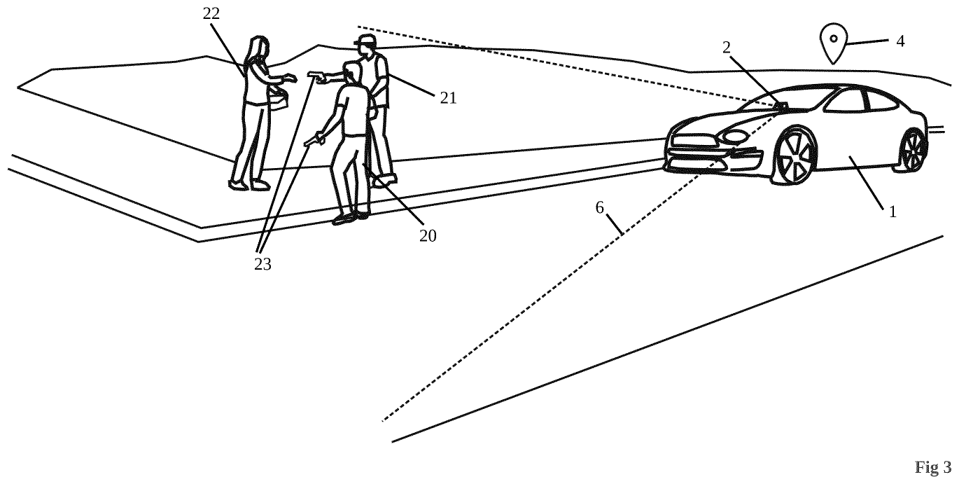

Further, it is illustrated in FIG. 3 showing a first vehicle equipped with a dashcam 2 having a field of view of an ongoing robbery scene according to one embodiment. Specifically, the figure illustrates a robbery scene captured by the dashcam 2 of a passing vehicle 1 according to one embodiment. The footage shows two armed robbers 20 and 21 brandishing guns 23 and accosting a victim 22 who is carrying a luggage bag 24.

While extremely valuable for identifying and catching the perpetrators, traditionally this video would be inaccessible to investigators and lost within days. The proposed system makes such footage discoverable. In some aspects, the robbery scene can be automatically detected from the video using machine learning models trained on recognizing crime incidents. Object detection may identify the weapons and distress behaviors, classifying the event as a likely robbery with high confidence.

Additionally, the faces of the robbers and victims may be extracted using facial recognition. Other visual details like clothing, heights, builds may also be cataloged through image analysis. Time, location and vehicles may be indexed as well. All this metadata is searchable. So an investigator may input details of the robbery time and location, number of suspects, weapons used etc. The computer vision module may analyze the stored visual metadata and identify the relevant incident footage, without needing manual review.

As such, an investigator may now access this invaluable evidence that places the robbers at the scene. Further analysis may identify the getaway vehicle and travel path based on footage from subsequent nearby dashcams. The faces can be cross-referenced with criminal databases to identify the suspects. Without the system, this video from a random passing vehicle would have been overwritten long before the crime was even discovered. By intelligently indexing the footage contents, the invented system makes such evidence reliably discoverable. This greatly empowers investigators with photographic leads and evidence, even without eyewitnesses. Machine learning may further automate and expedite sifting through footage to surface relevant incidents. The system transforms dashcams into powerful investigative tools.

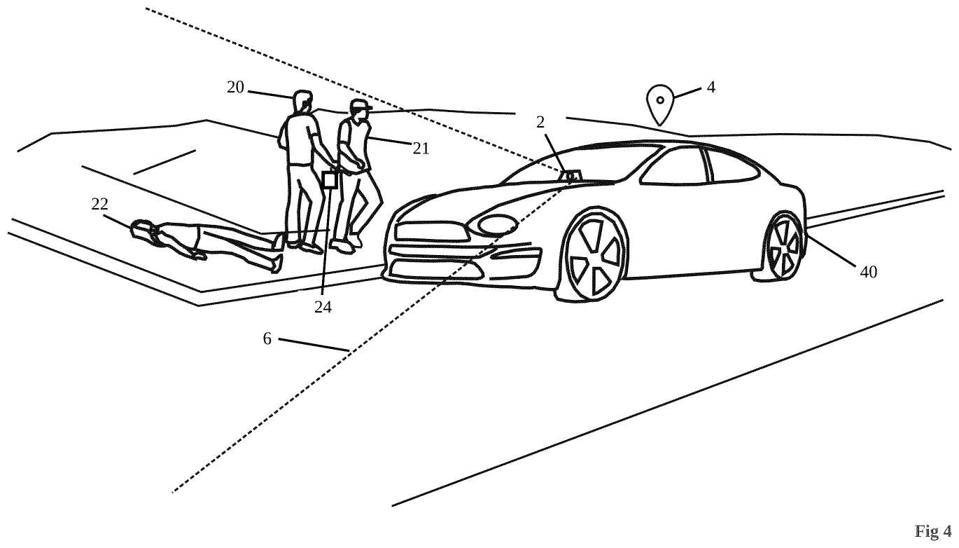

Further, FIG. 4 illustrates the same robbery scene as FIG. 3, but captured from the perspective of a second passing vehicle 40 equipped with a dashcam. This provides additional evidentiary value. The footage again captures the two robbers 20 and 21, now seen fleeing with the stolen luggage 24. The victim 22 is visible lying on the ground, having been assaulted during the robbery.

This second vantage point provides supplementary visual evidence corroborating the crime from an alternative angle. The additional perspective may reveal extra clues not observed in the first vehicle's footage, enhancing the investigatory reconstructions.

As with the first vehicle, real-time location data is transmitted by the second vehicle to the remote server while this footage is being captured. The GPS coordinates pinpoint the exact scene of the crime and escape path taken by the criminals.

The locations from both vehicles can be combined to track the movements of the robbers before, during and after the incident. This location mapping further aids investigators in reconstructing the crime chronology and tracking the escape route. The initial computer vision analysis of the first vehicle's footage can automatically flag this incident as a likely crime. The system then proactively searches other recent footage in the vicinity to turn up supplementary evidence like this second view.

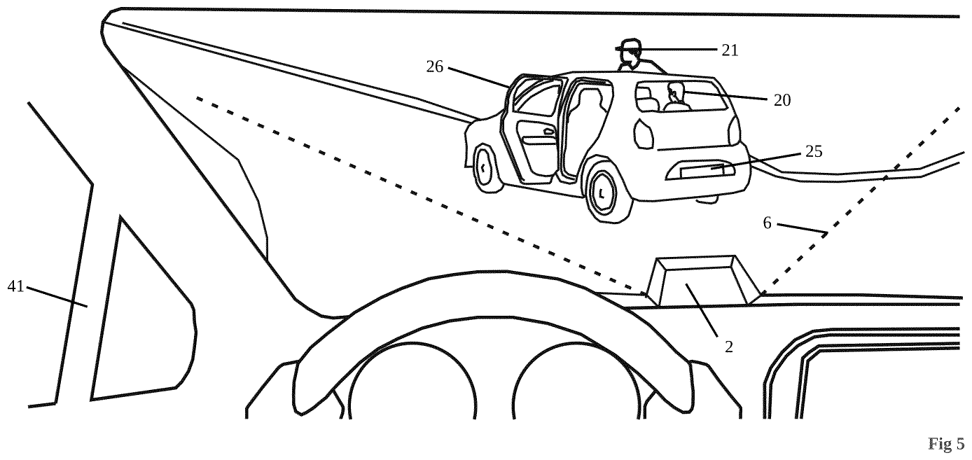

The embodiment according to FIG. 5 illustrates a third passing vehicle 41 capturing footage that follows the robbery suspects 20 and 21 escaping in a getaway car according to one embodiment. The two suspects are visible entering a vehicle with a license plate number. One robber may, for example, hold the stolen luggage 24, while the other robber keeps the door 26 open as his accomplice gets in.

This footage confirms the transition of the criminals from fleeing on foot to now escaping by car. The getaway vehicle's make, model, color and uniquely identifying license plate are clearly visible. As the vehicle drives off, the dashcam continues tracking it from a rear angle. This provides extended footage capturing the escape vehicle's movements, allowing investigators to trace its path beyond just the robbery scene.

The robber's faces are again visible here, further confirming their identity. The additional side profile angle aids in facial recognition and suspect matching. As with the earlier footage, real-time GPS coordinates are transmitted, now tracing the getaway path. The unbroken chain of location pings creates a map of the full robbery escape sequence. Combined with the earlier footage, this provides a continuous view into how the suspects arrived at the scene, committed the crime, and left afterward across three separate but stitched together dashcam perspectives.

Collecting data from all the different dashcams at a central server enables the aggregating and correlating insights from multiple vehicles, and as such, the system transforms an investigator's view from limited isolated glimpses into an integrated reconstructing of events. This enables uncovering the complete narrative.

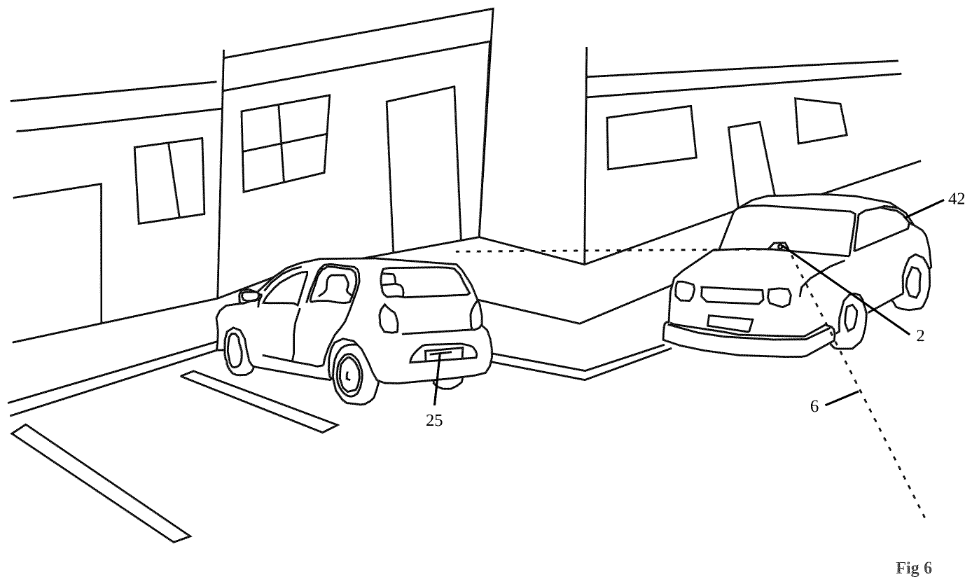

Reference is now made to FIG. 6 which illustrates a fifth vehicle 42 equipped with a dashcam capturing footage of the getaway vehicle 25 parked at an estate according to one embodiment. This is likely taken some time after the earlier footage, as the getaway car is now located at a different location, away from the robbery scene.

The license plate 25 is clearly visible, matching the plate identified on the escape vehicle earlier. This confirms it is the same car used during the crime. The vehicle being parked in a residential estate raises some key investigatory questions. Do the suspects live here or have associates at this address? Or did they simply abandon the getaway car at this location to avoid being tracked?

The new location highlights the importance of expanding the geo-spatial scope of footage analysis beyond just the initial crime scene. Valuable evidence emerges by broadening the radius and timeline around the incident. For example, blood or objects left in the car could again tie it to the suspects when combined with earlier footage. The estate's security cameras may in turn capture the suspects exiting the vehicle here. By following the ripples outwards, more evidentiary links appear, further solidifying the reconstructions. This also reveals subsequent patterns of behavior to better profile the suspects.

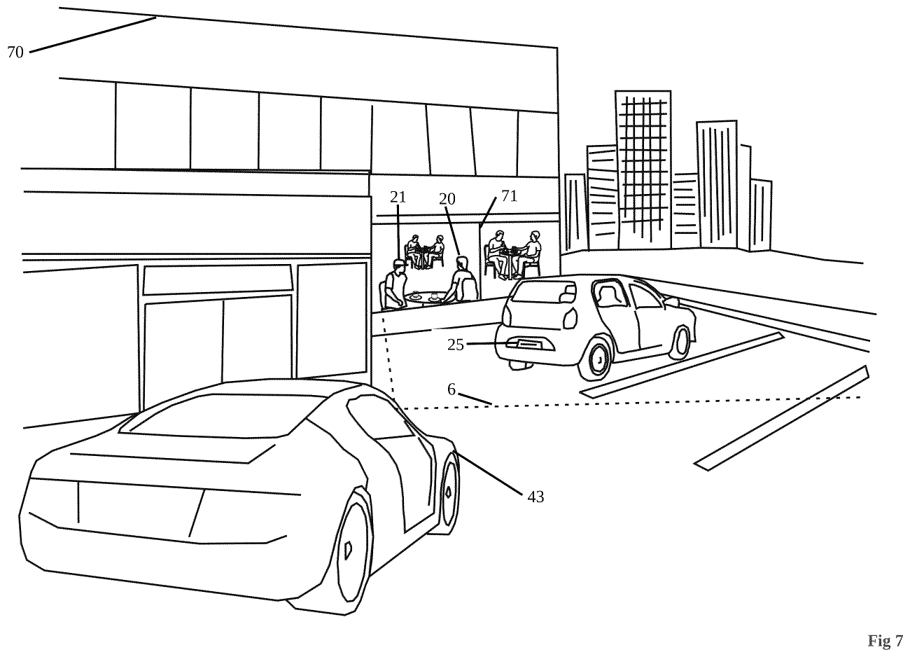

Further, FIG. 7 demonstrates footage from a sixth vehicle 43's dashcam capturing the two robbery suspects 20 and 21 at a mall 70 according to one embodiment. The suspects are visibly seated at an outdoor cafe 71 at the mall, suggestive of a social outing after the crime, or even many days after the crime occurred. Facial recognition analysis positively identifies the two faces matching those from the earlier robbery footage.

This sighting is from a significant time after the incident, possibly weeks later based on the suspects'changed clothing. Yet the system is able to rediscover them in everyday public settings far removed from the robbery. The vehicle may be parked in the mall's lot with a field of view overlooking the cafe area. As suspects go about normal public activities, the dashcam quietly captures their movements, demonstrating the power of distributed, perpetual crowd-sourced surveillance. Targets can be reacquired robustly after long gaps in the most unlikely places through recurring chance encounters.

By scaling up cameras and enabling intelligent re-identification, the ubiquity and persistence of the footage network allows picking up lost trails. Criminals make mistakes, and the system only needs one glimpse to put them back on the radar. The rediscovery here would spawn new investigatory directions—does the mall location suggest the suspects live nearby? Do they visit here often? Can mall security footage yield further clues when cross-referenced? Also, based on this implementation, criminals cannot just vanish into obscurity between distant cameras. The mesh nature ensures they remain perpetually detectable across a wide habitat.

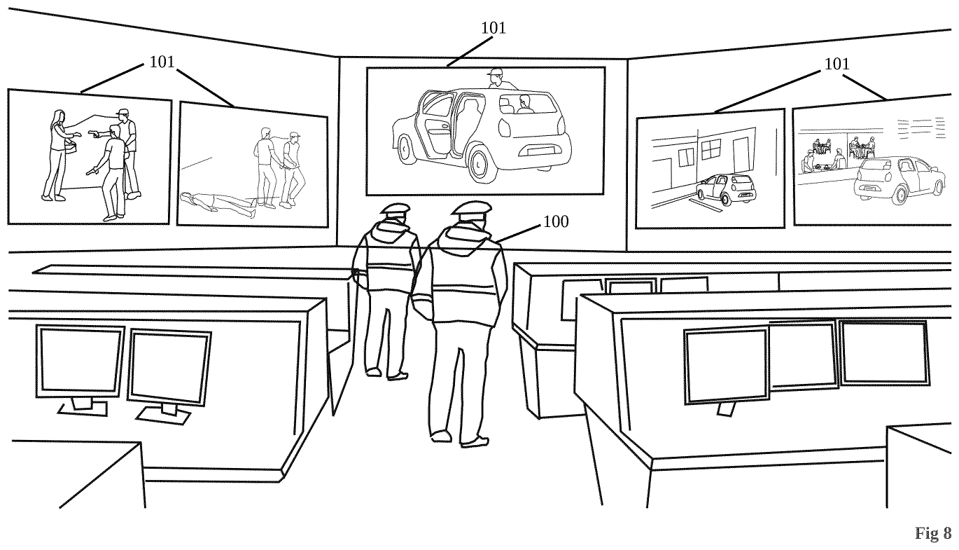

In the embodiment according to FIG. 8 it is illustrated an operator 100 using the system's interface 101 to search and analyze dashcam footage evidence. The interface 101 displays a multi-screen view showing the sequenced events and footage from FIG. 3 through FIG. 7 captured across the six vehicles.

This provides the operator an integrated overview of the entire robbery incident, escape, and subsequent sightings—stitched together cohesively across disparate footage that would otherwise remain fragmented. The operator may provide search criteria like the crime location, time, number and description of suspects, getaway vehicle etc. The system's computer vision algorithms then analyze stored footage to surface relevant media.

The interface 101 automatically assembles the matching clips sequentially to reconstruct the complete unfolding of events. The operator sees how the crime transpired from start to finish, gaining a comprehensive understanding. Key moments like the robbery, getaway, vehicle abandoning and reappearance of suspects are highlighted on the interface. The operator can further analyze the footage by zooming in, slowing down, and extracting stills. Additional capabilities like tracking suspect movements across locations, visually identifying elements like weapons or vehicles, establishing timelines, pinpointing addresses are also provided.

This interface enables harnessing the full investigative power of the system. Operators are empowered with tools to search, explore, analyze and derive insights in ways previously impossible from siloed, disconnected footage.

According to one aspect, when an operator or investigators discover relevant route metadata but the corresponding video was not uploaded, they can initiate a footage request through the system interface. Preferably, the driver's contact details stay anonymous. The request may explain the incident details and evidentiary value of footage captured based on time and location metadata. Drivers receive the requests and may voluntarily share the actual video evidence from their local dashcam storage. The freed-up footage gets analyzed by computer vision algorithms to extract further visual insights. It gets incorporated with the other reconstructed footage to provide a more complete overview of events.

In a non-limiting embodiment, the footage analysis module uses computer vision techniques like license plate recognition, facial recognition, object detection etc. to extract descriptive attributes about entities in the footage. This enables indexing and searching the contents.

In a non-limiting embodiment, advanced algorithms like image recognition, facial recognition and object detection are utilized to analyze footage and identify matches to search criteria specified by investigators.

In a non-limiting embodiment, the dashcam systems in vehicles can run embedded software to perform initial automated analysis of captured footage without needing to upload the video stream itself. This onboard software can utilize computer vision techniques like license plate recognition, facial recognition, scene text reading, and event detection algorithms to process and extract relevant metadata right on the camera device.

For example, license plate numbers of vehicles appearing in the footage can be read using optical character recognition and recorded as structured metadata. Facial recognition can identify faces in the video, log facial descriptors, and match to any databases of persons of interest. Scene text reading can pick out street signs, business names, addresses, and other textual elements from the background and catalog them. Additional techniques can detect incidents like accidents or traffic violations and flag them as events.

This metadata extracted on the edge can be incorporated into the route data package transmitted to the system, even if the footage itself is not streamed. When investigators search for suspects, vehicles, locations or events, this camera-generated metadata allows quickly surfacing relevant matches without needing the full video evidence.

Investigators can then request the original footage from the respective drivers to obtain the visual evidence. This approach balances efficient discovery using extracted metadata while minimizing bandwidth usage for transferring full video streams. It exemplifies how intelligent edge analysis combined with selective metadata sharing can enable performing key system functions even in bandwidth-constrained environments.

In a non-limiting embodiment, the path estimation module analyzes detected locations of suspects across cameras to determine likely routes and timings taken between sightings. This reconstructs their movements.

In a non-limiting embodiment, the system is implemented in a centralized server model that remotely accesses stored footage repositories as well as live streams from distributed cameras across multiple premises.

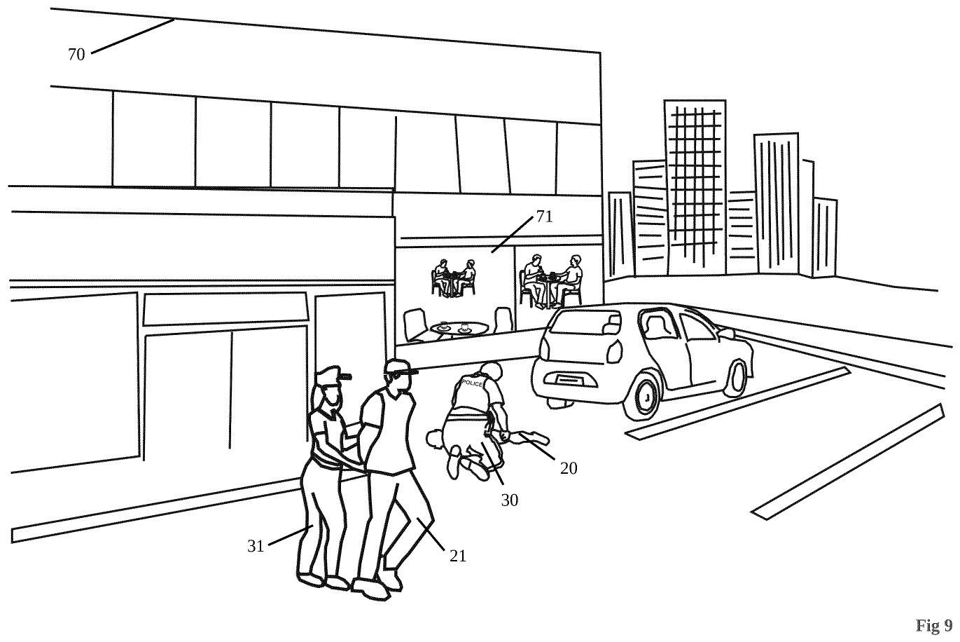

FIG. 9 is the culmination of the investigation, with police officers 30 and 31 arresting the robbery suspects 20 and 21 at the mall based on the earlier footage. The operators were able to reconstruct the entire crime timeline and re-identify the suspects through persistent tracking across multiple dashcams over time.

The initial crime scene footage from vehicles 1 and 2, getaway footage from vehicles 3 and 4, abandoned car footage from vehicle 5, and rediscovery of suspects at the mall by vehicle 6 were all aggregated and analyzed holistically. By inputting the robbery time, location and details as search parameters, the system was able to surface the relevant footage from across disconnected cameras. Powerful computer vision analysis stitched these fragments into an integrated sequence.

Object recognition identified the weapons, stolen goods, license plates and other artifacts. Facial recognition repeatedly matched the suspects across locations and weeks. Geotracking reconstructed their escape path. This finally culminated in the definitive identification of the suspects and prediction of their current location. The operators dispatched the officers to apprehend the criminals based on the irrefutable visual evidence chain.

The system hence transformed disjointed crowd-sourced glimpses into a cohesive story that connected the dots to catch the robbers. This showcases how integrating footage analysis with persistence hunting allows for unrelenting pursuit of suspects across space and time. No more vanishing into blindspots between cameras. The overlapping collective eyes become all-seeing. The invention fulfills the promise of ubiquitous video evidence by elevating fragmentation into continuity.

According to one aspect, multiple types of neural network architectures can be leveraged to enable various computer vision functionalities.

Convolutional neural networks (CNNs) are effective for image and video analysis tasks like license plate recognition, vehicle make/model classification, object detection, scene classification, optical character recognition of text in footage, etc. These networks can be trained with labeled dashcam images to identify vehicles, objects, text, logos and other entities accurately from pixels.

Recurrent neural networks, specifically long short-term memory networks (LSTMs) can help predict motion and trajectories of vehicles and human subjects across consecutive frames in videos. By analyzing sequences of images, LSTMs can provide motion foresight and enable tracking of objects across multiple frames.

For classifying short video clips, 3-dimensional convolutional networks are useful. These networks can ingest short video segments and classify the events and activities in them. This allows detecting incidents like accidents, traffic violations and crimes from brief footage.

In addition to visual data, audio from footage provides useful signals. Voice recognition neural networks can be applied to extract speech contents from dashcam audio. This speech-to-text capability allows searching footage by speech contents.

Dashcam video datasets with manual metadata tagging can be used to supervise the training process. The metadata can include coordinates, street names, vehicle license plates, makes/models, driver descriptions, speech contents and other attributes identifiable by humans. The models learn association between footage pixels/audio and these labeled attributes. Once trained to match human-level recognition, the models are deployed in the system to analyze new footage. The identified visual contents, text, speech, vehicle/human attributes etc. generated by the models are indexed to enable targeted search capabilities. Continual retraining on new data allows the machine learning models to become more robust. Active learning techniques can identify areas of improvement to prioritize data collection and augmentation to improve performance. The machine learning pipeline enables turning video pixels into structured investigative insights.

The disclosed system for aggregating and searching dashcam footage can be implemented through at least two approaches: a centralized architecture or a distributed peer-to-peer setup.

In a centralized architecture, vehicles transmit footage and route data to a remote centralized server, which handles the storage, computer vision analysis, and searching capabilities. In a distributed peer-to-peer setup, dashcam systems communicate directly with each other to share footage and enable localized searching.

The choice depends on factors like real-time analysis needs, volume of footage, and privacy considerations. A distributed approach may be favored when real-time direct sharing between vehicles is a priority. A centralized server could be preferable for storage-intensive historical analysis across large fleets.

The invention can manifest as a method, system, or computer program product, seamlessly integrating hardware and software components. The footage aggregation and targeted search capabilities can be enabled through code providing instructions to a general-purpose processor. This code could be encapsulated in various storage media.

Those skilled in the art may identify potential variations, substitutions, and additions within the spirit and scope of the invention. Such foreseeable modifications are intended to be encompassed, including broader applications beyond just investigations. Expanding the search capabilities to other use cases is one example.

The applicant aims to cover reasonable alterations aligning with the goal of making fragmented, inaccessible dashcam footage discoverable through centralized or distributed coordination. This applies whether using singular or plural terms, which should be interpreted expansively.

### INDUSTRIAL APPLICATION

The invention described herein finds significant industrial applicability in the investigative and surveillance domains. Law enforcement agencies can leverage it to enhance closure rates and caseload processing by unlocking access to valuable visual evidence from dashcam systems. Additionally, private security firms can utilize the capabilities for tracking persons of interest, securing premises, and gathering intelligence. Beyond investigations, the techniques can also enable smart fleet tracking, logistics monitoring, and location-based analytics for transportation companies. The industrial viability spans multiple sectors like law enforcement, private security, insurance, transportation, logistics, and more. Any industry relying on access to location-tagged video content can benefit from the invention's capabilities.

What is claimed is:

1. A computer-implemented method for tracking an object across multiple camera feeds comprising:
a. detecting an object of interest in footage from a first camera at a first location and time;
b. identifying features of the detected object from the first camera footage;
c. searching footage from a second camera proximal to the first location and time for presence of the object based on the identified features;
d. detecting the object in the second camera footage and determining a second location and time;
e. iteratively searching footage from additional cameras proximal to the second and subsequent locations and times to track the object based on the identified features, and
f. reporting the multiple locations and times wherein the object was detected across the camera network.

2. The method of claim 1, wherein the object of interest is one of a person, a vehicle, a license plate string, an address, or other physical objects.

3. The method of claim 1, wherein identifying features of the detected object comprises extracting descriptors related to the object's physical attributes.

4. The method of claim 3, wherein route metadata is transmitted to the system without uploading the full video footage, and wherein the route metadata comprises location coordinates, timestamps, and details extracted from the footage by onboard camera software.

5. The method of claim 1, wherein searching footage comprises using computer vision techniques to detect presence of the identified features in the camera feeds.

6. The method of claim 5, wherein the computer vision techniques include image recognition, facial recognition, or object detection algorithms.

7. The method of claim 1, further comprising estimating a path and timing of the object between the detected locations and times in the camera network.

8. The method of claim 1, further comprising notification to one or more persons of a route and/or video footage that includes the detected object.

9. A system for tracking an object of interest across a network of cameras comprising:
a. an interface to receive footage from a plurality of cameras;
b. a storage component to store the received camera footage;
c. an object detection module configured to detect an object of interest in a first camera's footage and identify distinctive features of the object;
d. an object tracking module configured to search stored footage from other cameras proximal in location and time to detect presence of the identified object based on its features;
e. a location tracking module configured to determine the different locations and times the object was detected; and
f. a reporting module to generate a report of the object's presence across the camera network.

10. The system of claim 9, further comprising a footage analysis module configured to extract object descriptors like physical attributes, license plate details, or facial features.

11. The system of claim 9, wherein route metadata is transmitted to the system without uploading the full video footage, and wherein the route metadata comprises location coordinates, timestamps, and details extracted from the footage by onboard camera software.

12. The system of claim 9, further comprising an object path estimation module configured to determine the likely path and timing between detected locations of the object.

13. The system of claim 9, wherein the interface is configured to receive real-time footage streams from the cameras to enable live tracking.

14. The system of claim 9, implemented in a server remotely accessing stored or streamed footage from networked cameras distributed across multiple locations.

15. A computer program product for tracking objects across cameras comprising:
a. a non-transitory computer readable medium; and
b. program instructions stored on the computer readable medium that when executed cause a processor to:
receive footage from a network of cameras;
detect an object of interest in footage of a first camera and identify distinctive features of the object;
search stored footage from other cameras proximal in time and location for presence of the identified object;
determine different locations and times the object was detected; and
generate a report of the object's presence across the camera network.

16. The computer program product of claim 15 further comprising instructions to extract descriptors related to the object's physical attributes like color, shape, license plate details or facial features.

17. The computer program product of claim 16, further comprising instructions to transmit route metadata to the system without uploading the full video footage, and wherein the route metadata comprises location coordinates, timestamps, and details extracted by object detection algorithms from the footage by onboard camera software.

18. The computer program product of claim 15 further comprising instructions to estimate a likely path and timing between the detected locations of the object.

19. The computer program product of claim 15 wherein the cameras comprise real-time footage streams or stored footage repositories.

20. The computer program product of claim 15 implemented in a server for accessing distributed cameras or stored footage from networked cameras.

21. A computer-implemented system for receiving and storing routes for which a vehicle camera has or is recording video footage that authorized users can search by coordinates, address, date/time, license plate string, person, vehicle, or other object of interest.

22. The system of claim 21 where the stored route contains video footage.

23. The system of claim 21 where the stored route contains metadata regarding addresses, coordinates, vehicles, persons, license plate strings, and details of other objects detected in the video footage such as weapons and events such as an accident or traffic infraction.

24. The system of claim 21 where the route may be transmitted at its beginning, before it is finished, allowing real-time transfer of video footage, coordinates, other metadata that describe the route, and objects detected in the video footage.

25. The system of claim 21 where the authorized user can request video footage from the driver(s) of route(s) that match the search criteria of the user.

26. The system of claim 21 where a driver may separately upload video footage of their route, which may be done manually or automatically when a device containing the un uploaded video footage is connected to wifi or a more suitable internet connection.
